(19) United States
(12) Patent Application Publication
(10) Pub. No.: US 2009/0184793 A1
(43) Pub. Date: Jul. 23, 2009

(54) Method to fabricate a molding coil structure and a molding coil structure

(76) Inventor: Huo-Li Lin, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/073,281

(22) Filed: Mar. 4, 2008

(30) Foreign Application Priority Data
Jan. 21, 2008 (TW) 97102253

(51) Int. Cl. H01F 27/02; H01F 7/06

(52) U.S. Cl. 336/83; 29/602.1

(57) ABSTRACT

A method to fabricate a molding coil structure and a molding coil structure are provided. The method comprises the steps of: providing a conductive mean comprising two conductive plates and a connection part, wherein each of the conductive plates comprise a first end and a second end; providing a coil; forming at least one winding structure on the first end of each conductive plates to make the two ends of the coil be adapted in the at least one winding structure of the two conductive plates respectively; performing a welding process to connect the two ends of the coil on the at least one winding structure of the two conductive plates respectively; placing the two conductive plates and the coil into a mold and stuffing a magnetic material to form a covering structure surrounding and contacting the two conductive plates and the coil to form the molding coil structure.

### RELATED APPLICATIONS

This application claims priority to Taiwan Application Serial Number 97102253, filed Jan. 21, 2008, which is herein incorporated by reference.

### BACKGROUND

1. Field of Invention

The present invention relates to a molding coil structure. More particularly, the present invention relates to a method to fabricate a molding coil structure and a molding coil structure.

2. Description of Related Art

Inductors are important elements of electronic circuits. Inductors can be used to store and release energy. Inductors eliminate disturbance from magnetic fields therefore making them ideal for implementation in today's shrinking electronic products. Many countries are making rules to set up a standard for the inductors. The inductor has thus becomes an important element of the electronic circuits.

The conventional method to fabricate an inductor is described as follow. FIG. 1A shows a top view of a coil 10 and two conductive plates 11 and 12. The fabricating method is to put two ends 100, 101 of the coil 10 respectively on first ends 110, 120 of the two conductive plates 11, 12 and further perform a welding process. After the welding process, stuffing a magnetic material under high pressure to surround and contact the coil 10 and the two conductive plates 11 and 12 to form a covering structure 13. The final structure is illustrated in FIG. 1B, a 3-D perceptive view of the inductor 1. During the stuffing process describe above, the connections between the two ends 100, 101 and the first ends 110, 120 are weak. Therefore, the two ends 110, 101 of the coil are easy to displace or deform during the high pressure stuffing process. Also, the small contact areas of the two ends 100, 101 and the first ends 110, 120 make weak electrical connections. These disadvantages lower the yield and the performance of the inductors.

Accordingly, what is needed is a method to fabricate a molding coil structure and a molding coil structure to strengthen the physical and electrical connection between the coil and the conductive plates to overcome the above issues. The present invention addresses such a need.

### SUMMARY

A method to fabricate a molding coil structure is provided. The method comprises the steps of: providing a conductive mean comprising two conductive plates and a connection part, wherein each of the conductive plates comprise a first end and a second end; providing a coil; forming at least one winding structure on the first end of each conductive plate to make the two ends of the coil be adapted in at least one winding structure of the two conductive plates respectively; and performing a welding process to connect the two ends of the coil on the winding structure of the two conductive plates respectively.

Another object of the present invention is to provide a molding coil structure. The molding coil structure comprises a molding coil, two conductive plates and a covering structure. The molding coil comprises two ends; the two conductive plates comprises a first end and a second end respectively, wherein the first end comprises at least one winding structure to make the two ends of the coil be adapted in at least one winding structure. The covering structure comprises a magnetic material and covers the molding coil and the two conductive plates. The second ends of the two conductive plates are exposed outside of the covering structure to electrically connect an outward circuit.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1A is a top view of a coil and two conductive plates of an inductor in the prior art;

FIG. 1B is a 3-D perceptive view of the inductor in the prior art;

FIG. 2A is a 3-D perceptive view of the molding coil structure of the first embodiment of the present invention;

FIG. 2B is a top view of a coil and two conductive plates of the first embodiment of the present invention;

FIG. 2C is a top view of a coil and two conductive plates of the second embodiment of the present invention;

FIG. 3 is a top view of the conductive mean of the present invention;

FIG. 4 is a top view of a coil and two conductive plates of the third embodiment of the present invention; and

FIG. 5 is a flow chart of a method to fabricate a molding coil structure of the fourth embodiment of the present invention.

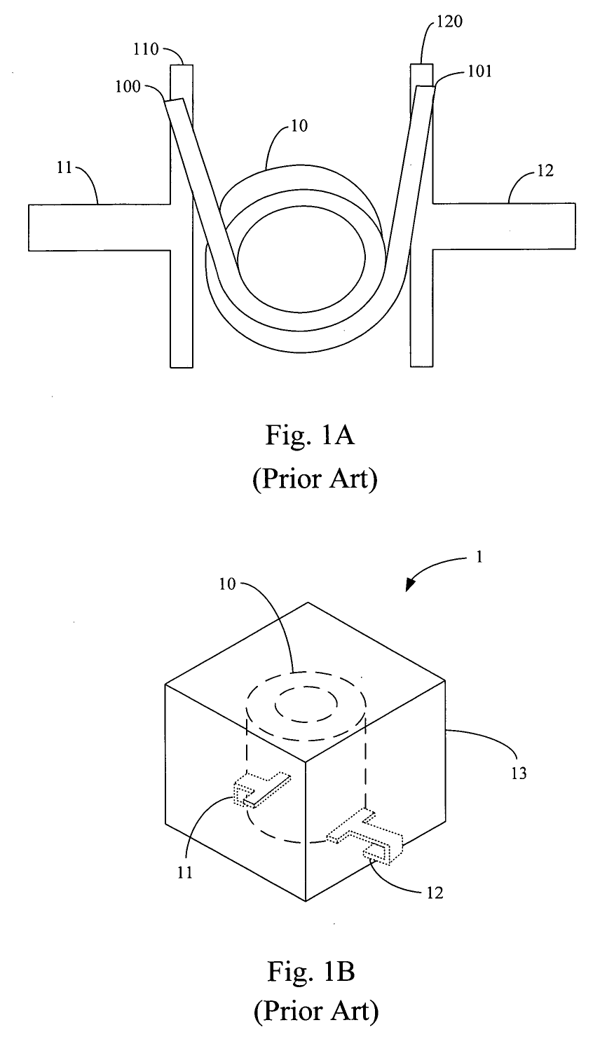

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

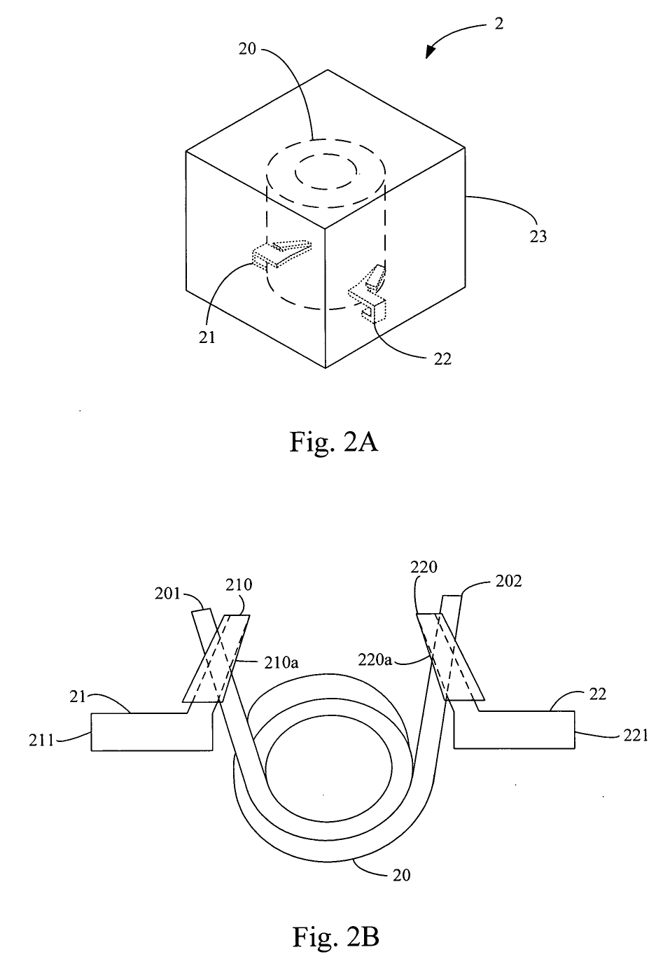

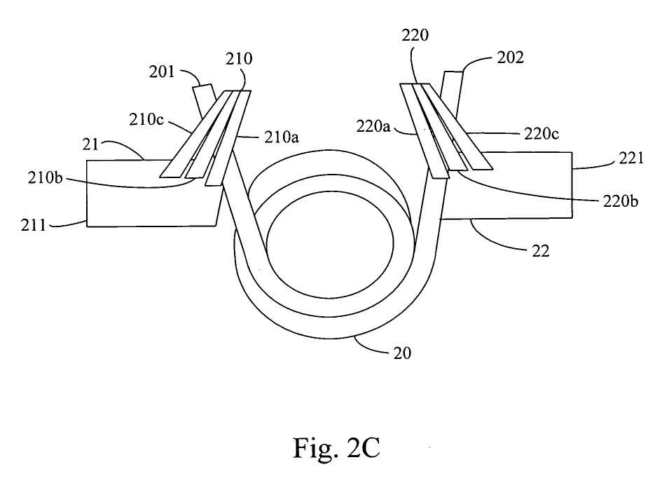

Please refer to FIG. 2A, a 3-D perspective view of a molding coil structure 2 of the first embodiment of the present invention. The molding coil structure 2 comprises a coil 20, two conductive plates 21 and 22 and a covering structure 23. As depicted in FIG. 2B, a top view of the coil 20 and the two conductive plates 21 and 22, the coil 20 comprises two ends 201 and 202; the two conductive plates respectively comprise a first end 210, 220 and a second end 211, 221. The first ends 210 and 220 respectively comprise a winding structure 210a, 220a to make the two ends 201 and 202 of the coil 20 be adapted in the winding structure 210a, 220a of the first ends 210, 220 respectively. In the present embodiment, the winding structure is a bent form as depicted in the FIG. 2B. The bent form of the winding structure provides a fastening function to fasten the two ends 201, 202 of the coil 20 into the bending form of the winding structure. Moreover, the contact area of the bent form is larger than the contact area of the form that has no winding structure on the first end 210, 220. The design of the winding structure thus reinforces the electrical connection between the coil and the conductive plates. In other embodiment, the first ends of the two conductive plates comprise more than one winding structure as depicted in FIG. 2C, a top view of a coil 20 and two conductive plates 21, 22 of the second embodiment of the present invention. The first ends 210′, 220′ of the conductive plates 21, 22 comprise three winding structures 210′a, 210′b, 210′c and 220′a, 220′b, 220′c respectively. The contact area and the fastening ability are both strengthen in the second embodiment.

After the fastening between the coil 20 and the two conductive plates 21, 22, a welding process is performed to completely fixed the coil 20 and the two conductive plates 21, 22 together. The welding process is a molten welding, a high frequency welding, a high pressure welding or a high temperature furnace welding process.

The covering structure 23 comprises a magnetic material and covers the two conductive plates 21, 22 and the coil 20 through a high pressure process. The conductive plates 21, 22 described above are substantially formed by performing a cutting process on a conductive mean 3. The conductive mean 3 comprises two conductive plates 21, 22 and a connection part 30, wherein the connection part 30 connects the second ends 211, 221 of the two conductive plates 21, 22 to prevent the displacement of the two conductive plates during the welding process and the formation of the covering structure. After the formation of the covering structure, a cutting process is performed on the connection part 30 to separate the two conductive plates 21 and 22. The second ends of the two conductive plates 21, 22 are exposed outside of the covering structure 23 to electrically connect an outward circuit respectively to perform an inductor function.

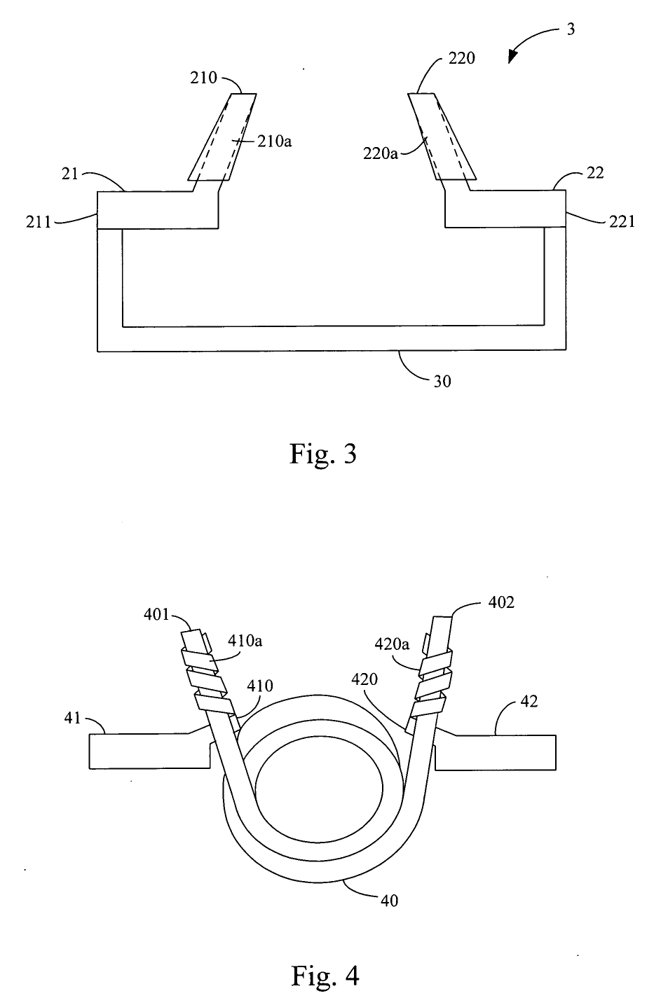

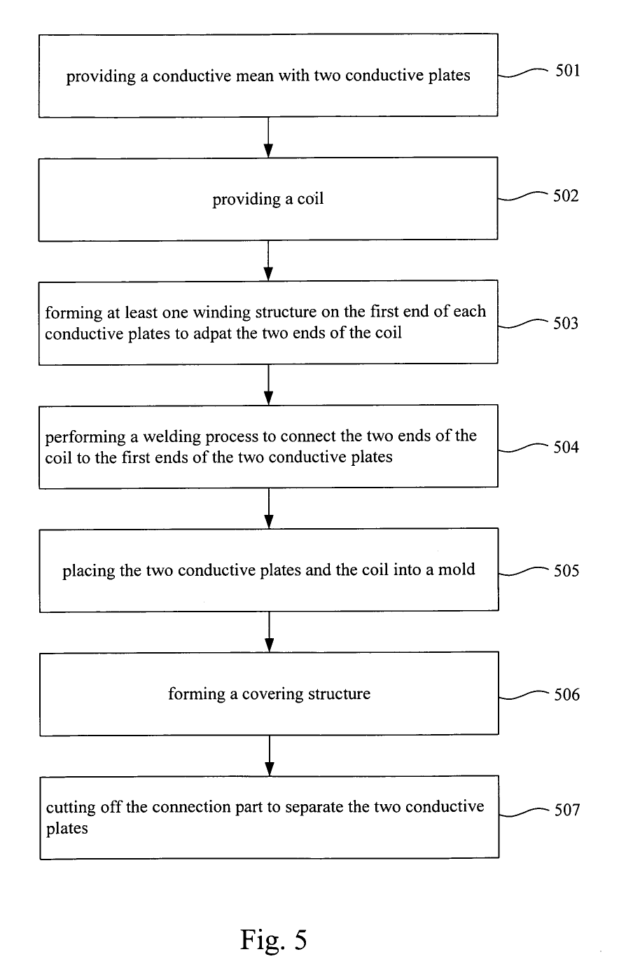

In the third embodiment of the present invention, the molding coil structure comprises a coil, two conductive plates and a covering structure as in the first embodiment. The difference between the third and the first embodiment is illustrated in FIG. 4, a top view of the coil 40 and two conductive plates 41, 42. The first ends 410, 420 of the two conductive plates have a spiral, not bending, form of winding structure 410a, 420a respectively. The spiral form of the winding structures 410a, 420a enwind the two ends 401, 402 of the coil and provide more contact area and stronger fastening ability. People skilled in the field can easily modify the number of the spiral form of the winding structure. Thus the detail is not described here.

The fourth embodiment of the present invention is a method to fabricate a molding coil structure. In step 501, a conductive mean is provided, wherein the conductive mean comprising two conductive plates and a connection part, wherein each of the conductive plates comprise a first end and a second end; in step 502, a coil is provided; in step 503, at least one winding structure is formed on the first end of each conductive plates to make the two ends of the coil be adapted in at least one winding structure of the two conductive plates respectively; in step 504, a welding process is performed to connect the two ends of the coil to at least one winding structure of the two conductive plates respectively; in step 505, the two conductive plates and the coil are placed into a mold and a magnetic material is stuffed therein to form a covering structure to surround and touch the two conductive plates and the coil to form the molding coil structure; then in step 507, the connection part is cut off to separate the two conductive plates.

The above embodiments show that the winding structures of the present invention can provide greater physical and electrical connection between the coil and the two conductive plates. Therefore, the performance of the inductor improves a lot due to the design in the present invention.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method to fabricate a molding coil structure comprising the steps of:
providing a conductive mean comprising two conductive plates and a connection part, wherein each of the conductive plates comprise a first end and a second end; the connection part connects the second ends of the two conductive plates;
providing a coil;
forming at least one winding structure on the first end of each conductive plate to make the two ends of the coil be adapted in at least one winding structure of the two conductive plates respectively; and
performing a welding process to connect the two ends of the coil on the winding structure of the two conductive plates respectively.

2. The method of claim 1, further comprising the steps of:
placing the connected molding coil and two conductive plates into a mold;
forming a covering structure by stuffing a magnetic material with a high pressure process to cover the two conductive plates and the molding coil to form the molding coil structure; and
cutting off the connection part to separate the two conductive plates.

3. The method of claim 1, wherein each of the winding structure is a bent form.

4. The method of claim 1, wherein each of the winding structures is a spiral form.

5. The method of claim 1, wherein the second ends of the two conductive plates are exposed outside of the covering structure to electrically connect to an outward circuit respectively.

6. The method of claim 1, wherein the welding process is a molten welding, a high frequency welding, a high pressure welding or a high temperature furnace welding process.

7. A molding coil structure comprising:
a molding coil comprising two ends;
two conductive plates respectively comprising:
a first end comprising at least one winding structure to make the two ends of the coil be adapted in at least one winding structure; and
a second end; and
a covering structure comprising a magnetic material and covering the molding coil and the two conductive plates; wherein the second ends of the two conductive plates are exposed outside of the covering structure to electrically connect an outward circuit.

8. The molding coil structure of claim 7, wherein the two conductive plates are formed by performing a cutting process on a conductive mean.

9. The molding coil structure of claim 8, the conductive mean comprises the two conductive plates and a connection part, wherein the connection part connects the second ends of the two conductive plates; the cutting process is performed to cut off the connection part and separate the two conductive plates.

10. The molding coil structure of claim 7, wherein each of the winding structure is a bending form.

11. The molding coil structure of claim 7, wherein each of the winding structure is a spiral form.

12. The molding coil structure of claim 7, wherein the two ends of the molding coil and the second ends of the two conductive plates are connected by a welding process.

13. The molding coil structure of claim 12, wherein the welding process is a molten welding, a high frequency welding, a high pressure welding or a high temperature furnace welding process.

14. The molding coil structure of claim 7, wherein the covering structure is formed by a high pressure process.
